(19) United States
(12) Patent Application Publication
(10) Pub. No.: US 2019/0136168 A1
(43) Pub. Date: May 9, 2019

(54) Alcoholic Beverages Containing Activated Charcoal

(71) Applicants: David H. Tegtmeier, Manhattan, KS (US); Danielle B. Tegtmeier, Manhattan, KS (US)

(72) Inventors: David H. Tegtmeier, Manhattan, KS (US); Danielle B. Tegtmeier, Manhattan, KS (US)

(21) Appl. No.: 16/183,481

(22) Filed: Nov. 7, 2018

Related U.S. Application Data
(60) Provisional application No. 62/582,755, filed on Nov. 7, 2017.

(51) Int. Cl. C12H 1/044; C12G 3/06

(52) U.S. Cl. CPC C12H 1/0408; C12G 3/06

(57) ABSTRACT

A method for improving liquor such as gin, vodka, or rum. A liquor is combined with activated charcoal at between 0.5% and 2.5% on a weight per volume basis of the liquor to form a mixture. The activated charcoal is bottled with the liquor to improve flavor and change the color of the liquor. The activated charcoal may sequester impurities so the consumer does not taste the impurities. Additionally, activated charcoal may prevent the consumer from digesting impurities that would otherwise cause the hangover effect. The liquor and activated charcoal combination may be bottled in a manner that agitating the bottle causes resuspension of the colorant to increase the contract of a partially transparent label.

### CROSS-REFERENCES

This application claims priority of U.S. Provisional Application No. 62/582,755, filed 7 Nov. 2017.

### FIELD

This disclosure generally relates to adsorbing fermentation byproducts of alcoholic beverages through the addition of activated charcoal and other additives to the beverage.

### BACKGROUND

Alcoholic beverages are commonly passed through a filter to remove impurities. A charcoal filter may be used to purify and clarify the distilled alcoholic beverage. Activated charcoal, charcoal that has been activated for adsorption by steaming or by heating in a vacuum, may also be used as a filter. Filtering through activated charcoal removes contaminants that contribute to harsh taste and smell of the alcoholic beverages. Higher end liquors, such as vodka, are filtered after the distillation process to remove distillation byproducts.

Activated charcoal is also sold as a nutritional supplement for detoxification. Activated charcoal can be ingested directly as an antidote for certain drugs and poisonings. Activated charcoal is also advertised to consumers as a dietary supplement, a general detoxifier, and to improve digestive health, gas, bloating, heart health, and anti-aging.

### SUMMARY

I recognized that adding charcoal as an additive flavoring agent to the liquors could improve the flavor of the liquor. By bottling the liquor together with the charcoal, the impurities and distilling byproducts are contained within the charcoal particulate. When the impurities are adsorbed into the charcoal particulate, the consumer does not taste the impurities. The flavor of a liquor may be improved by including between 0.5% and 2.5% on a weight per volume basis of activated charcoal having a mesh size of between 20-40.

I recognized that adding charcoal to liquor might lower toxin levels absorbed by the consumer of the liquor. Activated charcoal can be consumed as a detoxifying agent after the ingestion of a drug or poison. By mixing the charcoal with the beverage to be consumed, certain impurities might not be digested. This may prevent the ill effect that the impurity would otherwise cause to the consumer, such as hangover effects of headaches and nausea.

Another advantage of a liquor comprising activated charcoal is improving the flavor of the liquor. The activated charcoal may sequester ingredients having an unpleasant flavor, preventing those ingredients from being tasted when the liquor is consumed. The activated charcoal may bind to those ingredients and may deactivate them for tasting purposes.

I also recognized that adding activated charcoal to clear liquor as an additive or flavoring agent would result in the liquor appearing colored when the activated charcoal was in suspension. I also recognized that a transparent bottle of a transparent liquid having a non-transparent label would make the bottle appear unlabeled. Charcoal is added to the clear liquor as a colorant. When the bottle is undisturbed over a sufficient period of time, the charcoal would fall to the bottom of the bottle. Once the bottle is picked up, the clear liquid would be disturbed causing the charcoal to darken the liquor. Once the liquor was darkened, the non-transparent label would appear in greater contrast to the transparent portions of the bottle where the now-black liquid shows through. Alternatively, the bottle itself could be non-transparent with a transparent label portion. When the liquid is clear, the color of the back of the bottle will show through the transparent label portion. When the charcoal is distributed through the liquid, then the black color of the charcoal shows through the transparent label portion of the bottle.

### BRIEF DESCRIPTION OF DRAWINGS

Aspects are illustrated by way of example, and not by way of limitation, in the accompanying drawings, wherein:

FIG. 1 depicts a transparent bottle filled with a liquid having the charcoal additive settled to the bottom of the bottle, with a non-transparent label shown in dotted lines.

FIG. 2 depicts the transparent bottle of FIG. 1 with the charcoal distributed throughout the liquid increasing the color of the non-transparent label.

FIG. 3 depicts a transparent bottle having a non-transparent label that covers all but a transparent logo area, with the clear liquid showing through the transparent logo area.

FIG. 4 depicts the transparent bottle of FIG. 3, with the charcoal distributed throughout the liquid, increasing the contrast of the logo area compared with the non-transparent label.

FIG. 5 depicts a flow chart for a method for producing an improved liquor.

FIG. 6 depicts a flow chart for a process for increasing the contrast of a logo on a transparent bottle filled with a liquid when the transparent bottle is agitated.

### DETAILED DESCRIPTION

The flavor of alcohol can be improved by adding activated charcoal to the alcohol. The activated charcoal does not need to be removed. Instead of acting as a filter, the charcoal may sequester the impurities and improve the taste by preventing the impurities from being tasted by the consumer. The alcohol and the activated charcoal may then be bottled together to form an alcoholic beverage.

Adding particulate charcoal will change the color of a transparent liquor or spirit. Since the activated charcoal is insoluble, over time the activated charcoal will fall out of suspension and accumulate at the bottom. When the bottle is agitated the activated charcoal will return to suspension, like a snow globe.

The powdered activated charcoal may be added at less than 2.5% weight per volume of the uncolored liquor or spirit. Alternatively, the activated charcoal can be added at a ratio of 1 teaspoon of 20 to 40 mesh activated powdered charcoal in a 500 ml bottle of liquor. Alternatively, the 20 to 40-mesh activated charcoal can be added to the liquor at between 0.1 to 1.3 grams per 1.5 fluid ounces of liquor.

One advantage of this disclosure is the adsorbing of fermentation byproducts in a liquor without removing the byproducts or the adsorbing agent. The liquor distillation and fermentation processes commonly results in the presence of byproducts or contaminants. Fusel alcohols (or fusel oils) are by-products of fermentation. Fusel alcohol is primarily amyl alcohol. These fusel alcohols may contribute to hang over symptoms after imbibing the spirits containing the fusel alcohols. Other byproducts of the fermentation process may also contribute to the hangover effect. For example, congeners such as acetone, acetaldehyde, tannins and other higher alcohols (e.g. propanol and glycols) may contribute to the hangover of someone who has consumed the liquor.

The activated powdered charcoal may adsorb the fusel alcohol, congeners, or other byproducts present in the liquor. In this way, the presence of the activated charcoal enhances the flavor of the liquor and prevents side affects associated with the consumption of the fusel alcohols, congeners, or byproducts by preventing their absorption into the body of the person consuming the liquor.

The fermentation byproducts in a liquor can be adsorbed without removing the byproducts or the adsorbing agent from the liquid by providing an uncolored liquor or spirit and adding powdered activated charcoal at less than 2.5% weight per volume of the uncolored liquor or spirit. For example, 20 to 40-mesh activated charcoal can be added to the liquor at between 0.1 to 1.3 grams per 1.5 fluid ounces of liquor. Alternatively, up to 1 teaspoon of 20- to 40-mesh powdered activated charcoal can be added to 500 ml of a liquor. Alternatively, between 0.1 to 1.0 grams of activated charcoal can be added per fluid ounce of the liquor.

The color of a liquor can be changed by providing 20- to 40-mesh activated charcoal to the liquor at between 0.1 to 1.3 grams per 1.5 fluid ounces of liquor. The color of vodka, rum, or gin can be changed using the activated charcoal. For example, adding up to 2.5% on a weight per volume basis of activated charcoal having a mesh size of between 20-40 can be used to change the color. Alternatively, between 0.5% and 2.5% of activated charcoal can be added to the liquor on a weight per volume basis.

An advantage of the current disclosure is the activated charcoal may lower toxin levels. Another advantage of the current disclosure is that the activated charcoal may act as a cleansing agent.

Another advantage of a liquor comprising activated charcoal is improving the flavor of the liquor. The activated charcoal may sequester ingredients having an unpleasant flavor, preventing those ingredients from being tasted when the liquor is consumed. The activated charcoal may bind to those ingredients and may deactivate them for tasting purposes.

The activated charcoal is a powdered, activated charcoal. The activated charcoal can be made from bamboo, hardwood, bone char, peat, petroleum coke, coal, olive pits, saw dust, coconut or other source. The activated charcoal must be food grade. In a preferred embodiment, the charcoal is bamboo charcoal. The charcoal may be powdered and screened at a mesh size of 20 to 40.

Activated charcoal is charcoal that has expanded surface area. Activated charcoal adsorbs toxins and other chemicals in the gut, preventing their absorption into the body. However, the charcoal is not absorbed into the body, so any toxins or chemicals adsorbed by the activated charcoal pass through. Activated carbon, or activated charcoal may provide numerous health benefits, including: absorbing toxins and sequestering fusel alcohol.

Liquor is regularly filtered with a granular charcoal filter. However, the liquor merely passes through the filter material. According to the current disclose, the activated powdered charcoal is maintained in suspension with the liquor.

By adsorbing fermentation byproducts in a liquor without removing the byproducts or the adsorbing agent, the flavor is improved and the byproducts may not be absorbed into the consumer's body. A filtration process removes certain quantities of byproducts, but is only performed for a short amount of time. By packaging the charcoal with the liquor, the exposure time is dramatically increased. In the current disclosure, the powdered charcoal is maintained in the bottled liquor in suspension. The powdered activated charcoal may fall out of suspension due to gravity over time. The activated charcoal may be re-suspended by shaking or inverting the bottle.

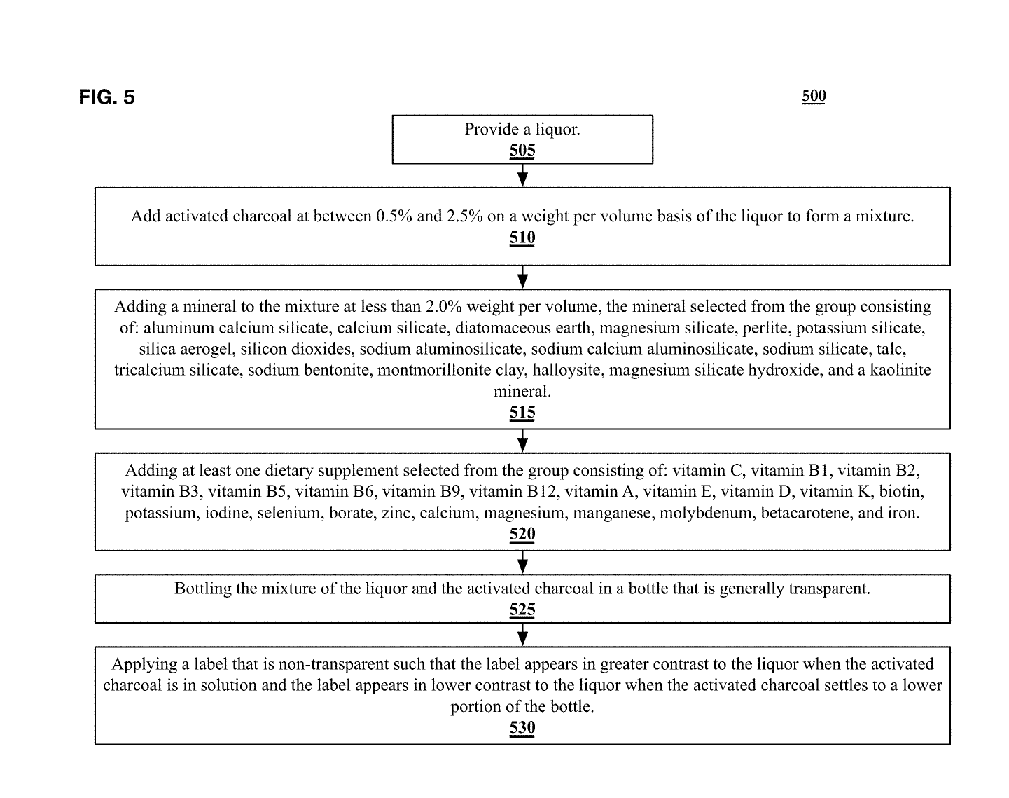

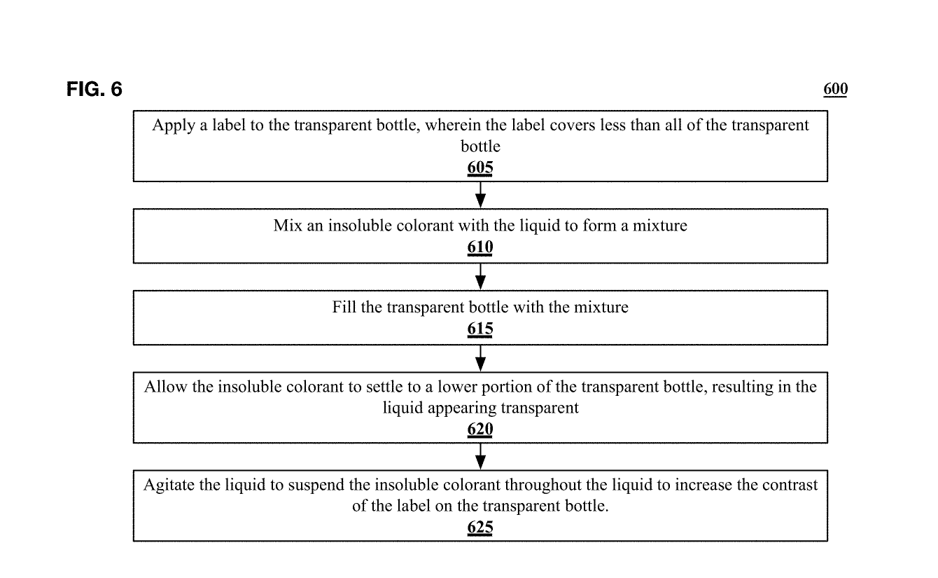

A method for producing an improved liquor is shown in FIG. 5. As shown in step 505, a liquor is provided. As shown in step 510, activated charcoal at between 0.5% and 2.5% on a weight per volume basis of the liquor is added to the liquor to form a mixture. As shown in optional step 515, a mineral may be added to the mixture at less than 2.0% weight per volume, the mineral selected from the group consisting of: aluminum calcium silicate, calcium silicate, diatomaceous earth, magnesium silicate, perlite, potassium silicate, silica aerogel, silicon dioxides, sodium aluminosilicate, sodium calcium aluminosilicate, sodium silicate, talc, tricalcium silicate, sodium bentonite, montmorillonite clay, halloysite, magnesium silicate hydroxide, and a kaolinite mineral. As shown in optional step 520, at least one dietary supplement may be added to the mixture. The dietary supplement is selected from the group consisting of: vitamin C, vitamin B1, vitamin B2, vitamin B3, vitamin B5, vitamin B6, vitamin B9, vitamin B12, vitamin A, vitamin E, vitamin D, vitamin K, biotin, potassium, iodine, selenium, borate, zinc, calcium, magnesium, manganese, molybdenum, betacarotene, and iron. As shown in optional step 525, the mixture comprising the liquor and the activated charcoal may be bottled in a bottle that is generally transparent. The bottle can be glass or plastic. As shown in optional step 530, a label that is non-transparent may be applied to the bottle. The label will appear in greater contrast to the liquor when the activated charcoal is in solution. The label will appear in lower contrast to the liquor when the activated charcoal settles to a lower portion of the bottle.

A process for increasing the contrast of a logo on a transparent bottle filled with a liquid when the transparent bottle is agitated is shown in FIG. 6. As shown in step 605, a label is applied to a transparent bottle. The label covers less than all of the transparent bottle, maintaining a portion of the transparent bottle exposed. As shown in step 610, an insoluble colorant is mixed with the liquid to form a mixture. In one embodiment, the insoluble colorant is particulate activated charcoal having a mesh size of 20-40. As shown in step 615, the transparent bottle is filled with the mixture. As shown in step 620, the insoluble colorant settles to a lower portion of the transparent bottle under the force of gravity. This results in the liquid appearing transparent. As shown in step 625, the liquid can be agitated to suspend the insoluble colorant throughout the liquid. Resuspending the insoluble colorant increases the contrast of the label on the transparent bottle. Such change in contrast can be a dramatic marketing effect. For example, a transparent bottle having a white label will appear to be unlabeled due to the lack of contrast between the transparent liquid and the white label. When the consumer picks up the bottle, the consumer agitates the liquid causing the insoluble colorant to be resuspended. This resuspension imparts a color throughout the liquid, similar to the effect of a snow globe. The colored background increases the contrast between the liquid and the label, making the label appear more dramatic and with higher contrast then the bottles that remain on the shelf.

In one embodiment, calcium is also added to the mixture at less than 2.0% weight per volume. Calcium may be added at 0.5 to 10 grams

In one embodiment, zeolite is also added to the mixture at less than 2.0% weight per volume. Zeolite can be used instead of or in addition to the activated charcoal. Zeolite is a naturally occurring mineral made of volcanic material. There are also synthetic zeolites that have similar chemical composition and physical characteristics. Zeolite is a hydrous sodium aluminosilicate that is provided industrially as granules and powders. The general chemical formula for zeolite is Na₆[Al₆Si₃₀O₇₂]₂₄H₂O. Zeolite is provided at a mesh size of 20 to 40. There are many forms of zeolite, any of which may be used. In one embodiment, the zeolite is clinoptilolite.

In another embodiment, a mineral is added to the alcoholic beverage. The mineral may be added less than 2.0% weight per volume. The mineral is selected from the group consisting of: aluminum calcium silicate, calcium silicate, diatomaceous earth, magnesium silicate, perlite, potassium silicate, silica aerogel, silicon dioxides, sodium aluminosilicate, sodium calcium aluminosilicate, sodium silicate, talc, tricalcium silicate, sodium bentonite, montmorillonite clay, halloysite, magnesium silicate hydroxide, a kaolinite mineral, a member from the montmorillonite/smectite group, a member of the illite group, a member of the chlorite group, and a combination thereof.

In one embodiment, a liquor mixture comprises 500 ml of a liquor such as vodka, rum, or gin and a teaspoon of a mixture of between 1 to 4 parts activated charcoal and 1 part zeolite. In one embodiment, the liquor mixture comprises a liquor such as vodka, rum, or gin and up to 2.5% on a weight per volume basis of a mixture of between 1 to 5 parts activated charcoal; and 1 part of a clay selected from the group consisting of: zeolite, bentonite, montmorillonite, and illite.

In one embodiment, a liquor mixture comprises 500 ml of a liquor such as vodka, rum, or gin and a teaspoon of a mixture of between 1 to 4 parts activated charcoal and 1 part calcium. In one embodiment, the liquor mixture comprises a liquor such as vodka, rum, or gin and up to 2.5% on a weight per volume basis of a mixture of between 1 to 5 parts activated charcoal and 1 part calcium.

In one embodiment, the liquor contains additives to further improve the taste or smoothness of the liquor. Additives can include sugar, glucose syrups, glycerol or citric acid. For example, glycerol can be added between 0.1% and 0.5% or between 0.2% and 1.0% to improve smoothness. As another example, sugar can be added between 0.1% and 0.5% or between 0.2% and 1.0% weight per volume. As another example, citric acid can be added between 0.1% and 0.5% or between 0.2% and 1.0% weight per volume. Additives may also include flavoring agents that are known in the art.

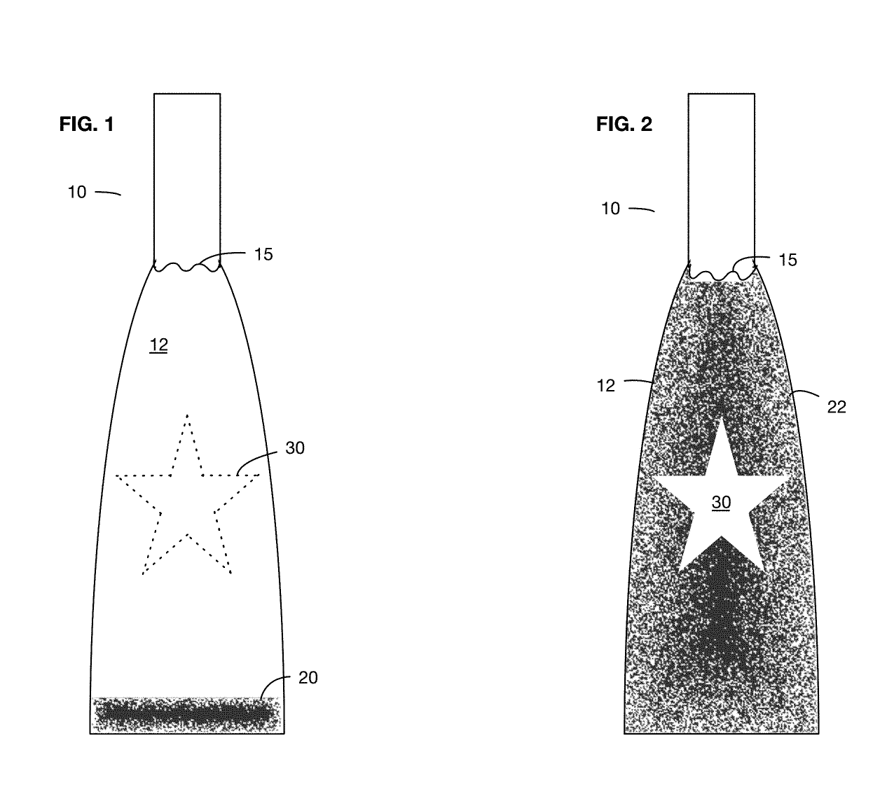

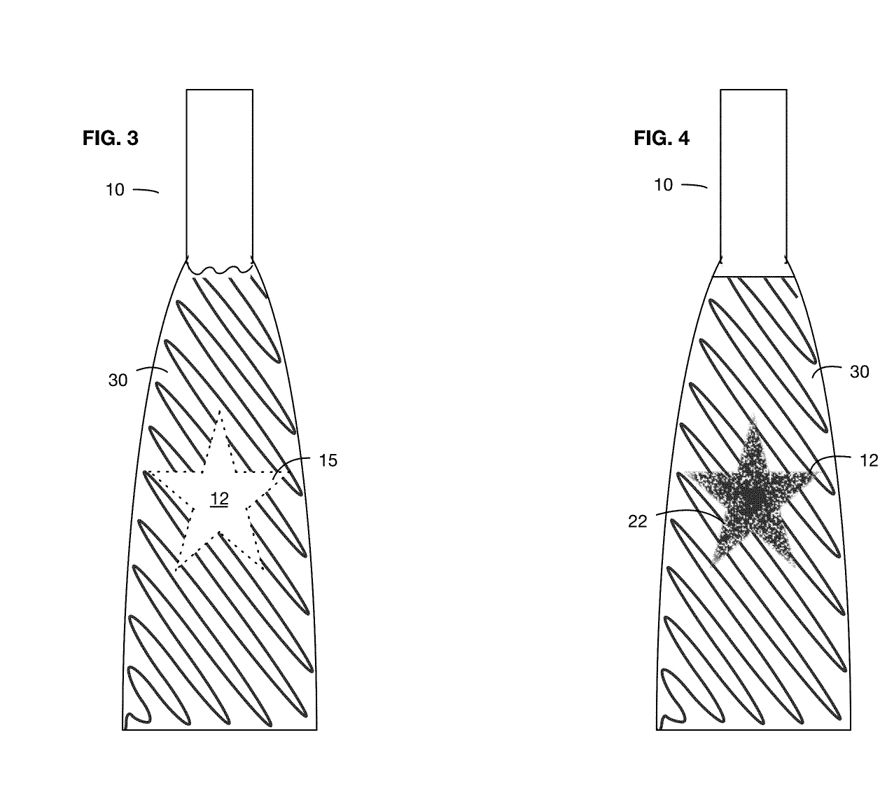

The contrast of a label on a transparent bottle can be selectively increased filled, as shown in FIGS. 1-4, by including an insoluble colorant in the transparent liquid. The label 30 is applied to the transparent bottle 10. The label 30 covers less than all the surface of the transparent bottle 10, leaving a transparent bottle portion 12. A quantity of an insoluble colorant is mixed with the liquid to form a mixture with the transparent liquid 15. The bottle 10 is filled with the mixture. The insoluble colorant settles to the bottom of the transparent bottle over time due to the force of gravity to form a settled colorant layer 20. This results in the transparent liquid 15 to appear transparent as the colorant is at a bottom portion of the bottle in the settled colorant layer 20. Agitating the liquid causes the insoluble colorant to become suspended in the liquid, forming a colorant suspension 22. The contrast of the label 30 and the bottle is selectively increased when the insoluble colorant is suspended in the liquid.

Besides activated charcoal, insoluble colorants may include insoluble lake colors such as: Lake Allura Red, Lake Erythrosine, Lake Sunset Yellow, Lake Tartrazine, Lake Carmoisine, Lake Brilliant Blue, Lake Quinoline Yellow, Lake Indigo Carmine, Lake Amaranth, Lake Carmoisine, and Lake Ponceau 4R.

1. A method of producing an improved liquor comprising the steps of:
a. providing a liquor; and
b. adding activated charcoal at between 0.5% and 2.5% on a weight per volume basis of the liquor to form a mixture.

2. The method of claim 1, wherein the liquor is selected from the group consisting of:
vodka, rum, and gin.

3. The method of claim 1, wherein the activated charcoal has a mesh size of 20 to 40.

4. The method of claim 3, further comprising the step of:
a. bottling the mixture of the liquor and the activated charcoal in a bottle that is generally transparent; and
b. applying a label that is non-transparent such that the label appears in greater contrast to the liquor when the activated charcoal is in solution and the label appears in lower contrast to the liquor when the activated charcoal settles to a lower portion of the bottle.

5. The method of claim 1, further comprising the step of:
a. bottling the mixture of the liquor and the activated charcoal in a bottle that is generally transparent; and
b. applying a label having a logo portion that is transparent, such that the logo portion appears in greater contrast to the liquor when the activated charcoal is in solution and the logo portion appears in lower contrast to the liquor when the activated charcoal settles to a lower portion of the bottle.

6. The method of claim 1, further comprising the step of:
a. adding a mineral to the mixture at less than 2.0% weight per volume, the mineral selected from the group consisting of: aluminum calcium silicate, calcium silicate, diatomaceous earth, magnesium silicate, perlite, potassium silicate, silica aerogel, silicon dioxides, sodium aluminosilicate, sodium calcium aluminosilicate, sodium silicate, talc, tricalcium silicate, sodium bentonite, montmorillonite clay, halloysite, magnesium silicate hydroxide, and a kaolinite mineral.

7. The method of claim 6, further comprising the step of:
a. adding at least one dietary supplement selected from the group consisting of: vitamin C, vitamin B1, vitamin B2, vitamin B3, vitamin B5, vitamin B6, vitamin B9, vitamin B12, vitamin A, vitamin E, vitamin D, vitamin K, biotin, potassium, iodine, selenium, borate, zinc, calcium, magnesium, manganese, molybdenum, betacarotene, and iron.

8. The method of claim 1, further comprising the step of:
a. adding calcium to the mixture at between 0.42% to 1.25% weight per volume.

9. The method of claim 8, further comprising the step of:
a. adding at least one dietary supplement selected from the group consisting of: vitamin C, vitamin B1, vitamin B2, vitamin B3, vitamin B5, vitamin B6, vitamin B9, vitamin B12, vitamin A, vitamin E, vitamin D, vitamin K, biotin, potassium, iodine, selenium, borate, zinc, calcium, magnesium, manganese, molybdenum, betacarotene, and iron.

10. An alcoholic beverage comprising:
a. a liquor; and
b. activated charcoal, from 0.5% and 2.5% on a weight per volume basis of the liquor.

11. The alcoholic beverage of claim 10 further comprising:
a. a mineral, from 0.1% to 2.0% on a weight per volume basis of the liquor, the mineral selected from a group of: aluminum calcium silicate, calcium silicate, diatomaceous earth, magnesium silicate, perlite, potassium silicate, silica aerogel, silicon dioxides, sodium aluminosilicate, sodium calcium aluminosilicate, sodium silicate, talc, tricalcium silicate, sodium bentonite, montmorillonite clay, halloysite, magnesium silicate hydroxide, and a kaolinite mineral.

12. The alcoholic beverage of claim 10 further comprising:
a. At least one dietary supplement selected from the group consisting of: vitamin C, vitamin B1, vitamin B2, vitamin B3, vitamin B5, vitamin B6, vitamin B9, vitamin B12, vitamin A, vitamin E, vitamin D, vitamin K, biotin, potassium, iodine, selenium, borate, zinc, calcium, magnesium, manganese, molybdenum, betacarotene, and iron.

13. The alcoholic beverage of claim 12, further comprising:
a. a mineral, from 0.1% to 2.0% on a weight per volume basis of the liquor, the mineral selected from a group of: aluminum calcium silicate, calcium silicate, diatomaceous earth, magnesium silicate, perlite, potassium silicate, silica aerogel, silicon dioxides, sodium aluminosilicate, sodium calcium aluminosilicate, sodium silicate, talc, tricalcium silicate, sodium bentonite, montmorillonite clay, halloysite, magnesium silicate hydroxide, and a kaolinite mineral.

14. The alcoholic beverage of claim 12, further comprising:
a. calcium, from between 0.42% to 1.25% weight per volume.

15. A process for increasing the contrast of a logo on a transparent bottle filled with a liquid when the transparent bottle is agitated, the process comprising the steps of:
a. applying a label to the transparent bottle, wherein the label covers less than all of the transparent bottle;
b. mixing an insoluble colorant with the liquid to form a mixture;
c. filling the transparent bottle with the mixture;
d. Allowing the insoluble colorant to settle to a lower portion of the transparent bottle, resulting in the liquid appearing transparent; and
e. Agitating the liquid to suspend the insoluble colorant throughout the liquid to increase the contrast of the label on the transparent bottle.

16. The process of claim 15, wherein the insoluble colorant is activated charcoal having a mesh size of 20 to 40, which is added at a rate of between 0.5% and 2.5% weight per volume.

17. The process of claim 15, wherein the insoluble colorant is activated charcoal.

18. The process of claim 17, wherein the label has an outside edge that is colored white.
